(19) United States
(12) Patent Application Publication
(10) Pub. No.: US 2026/0052296 A1
(43) Pub. Date: Feb. 19, 2026

(54) System and Method for Enhanced ATSC 3.0 Broadcasting

(71) Applicant: Anywave Communication Technologies Inc., Vernon Hills, IL (US)

(72) Inventors: Yingying Fan, Hawthorn Woods, IL (US); Pan Xia, Hawthorn Woods, IL (US); Bowei Song, Hawthorn Woods, IL (US); Jingsong Xia, Hawthorn Woods, IL (US); Edward Karam, West Suffield, CT (US)

(21) Appl. No.: 19/247,700

(22) Filed: Jun. 24, 2025

Related U.S. Application Data
(60) Provisional application No. 63/663,371, filed on Jun. 24, 2024.

(51) Int. Cl. H04N 21/61; H04N 21/438; H04N 21/643

(52) U.S. Cl. CPC H04N 21/6106; H04N 21/438; H04N 21/643

(57) ABSTRACT

A method for enhanced broadcasting in an ATSC 3.0 system includes: selectively choosing among various input sources available to components within the system, including STLTP (Studio to Transmitter Link Transport Protocol), ALPTP (ATSC Link-layer Protocol Transport Protocol), DS (Data Source), and RF (off-air signals); inserting local content into a broadcast stream by at least one component within the system; and regenerating standard-compliant signaling information to ensure compatibility with ATSC 3.0 standards.

### CROSS-REFERENCE TO RELATED APPLICATION

This application claims priority to U.S. Patent Application No. 63/663,371, filed Jun. 24, 2024, the disclosure of which is hereby incorporated by reference in its entirety.

### BACKGROUND

### 1. Field

This disclosure relates generally to systems and methods for enhanced Advanced Television Systems Committee (ATSC) 3.0 broadcasting.

### 2. Description of Related Art

Traditionally, multi-transmitter ATSC 3.0 broadcast setups have centralized much of the front-end equipment, such as Advanced Emergency Alert (AEA), Electronic Service Guide (ESG), signal generators, encoders, multiplexers, signaling servers, and broadcast gateways, in a single location, typically the studio. These setups streamline content generation and distribution, with the broadcast gateway transmitting the main streams to one or more exciters at transmitter sites via STLTP format over an IP network. This arrangement facilitates modulation and broadcast of signals for desired coverage, whether in multi-frequency network (MFN) or single-frequency network (SFN) settings.

However, the limitation of this centralized approach is that all exciters broadcast identical content since they are preconfigured by the front-end equipment in the studio. Moreover, standard ATSC 3.0 exciters cannot modify content, including media content (audio/video programs) and signaling information (such as service ID, channel name, and major/minor channel numbers). This limitation restricts stations from “cherry-picking” programs or inserting local content into the main streams, thereby limiting flexibility and customization options.

While separate front-end equipment setups for each station could address these limitations, such an approach comes with significant drawbacks. Firstly, it substantially increases installation costs, as each transmitter would require its own set of front-end equipment. Additionally, managing the full spectrum of broadcast content becomes the responsibility of each station, potentially overwhelming smaller broadcasters or those operating within tight budget constraints. Also, many stations that currently share front-end equipment have not fully embraced the ATSC 3.0 broadcast market, as the rollout of the new standard is still in its early stages. These broadcasters may prioritize having a diverse range of readily available content to attract viewers and establish their presence in the market. Thus, centralized content acquisition and distribution remain appealing despite their limitations.

Moreover, this limitation extends to exciters receiving off-air signals from a main transmitter, which function as translators. Although recent FCC rules provide translators with more flexibility, allowing them to multiplex programs from multiple TV stations and transmit limited local content (such as emergency alerts, public service announcements, and acknowledgments of financial support), typical translators face the same challenge. They lack the necessary functionality to “cherry-pick” or insert local content without the essential functions provided by certain front-end equipment, including signaling servers and broadcast gateways. Thus, the implementation of this flexibility remains costly and complicated for both translators and traditional stations sharing front-end equipment.

In summary, the current industry landscape highlights the need for solutions that balance centralized content distribution and localized content insertion. Such solutions would empower broadcasters to optimize their programming strategies, enhance viewer engagement, and maintain competitiveness in the ATSC 3.0 broadcast market.

### SUMMARY

The present disclosure addresses the limitations and requirements of current ATSC 3.0 broadcast systems by introducing a method and system that enables TV stations to selectively choose among various input sources available to exciters. These sources include but are not limited to, STLTP (Studio to Transmitter Link Transport Protocol), ALPTP (ATSC Link-layer Protocol Transport Protocol), DS (Data Source), and off-air signals (RF). Additionally, the system and methods of the present disclosure allow for the insertion of local content by the exciter. By leveraging this method and system, TV stations gain the flexibility to curate and customize their broadcast content, thereby enhancing viewer engagement and meeting localized programming needs.

In contrast to traditional multi-transmitter ATSC 3.0 broadcast setups, characterized by centralized content distribution and limited customization options, the present disclosure enables TV stations to overcome these limitations. By providing a method and system for cherry-picking input sources and inserting local content, the invention empowers stations to tailor their programming to meet the diverse needs and preferences of their audience. Furthermore, the system and method of the present disclosure facilitate the regeneration of standard-compliant signaling information, ensuring seamless integration with existing ATSC 3.0 infrastructure.

The method and system presented in the present disclosure comprise several key technical aspects that include:

Input Source Selection: The system and method of the present disclosure allow TV stations to select from a range of input sources, including STL(TP), ALP(TP), Data Source, and off-air signals, providing flexibility in content acquisition.

Local Content Insertion: Exciters are equipped with the capability to insert local content into the broadcast stream, enabling stations to deliver targeted programming and public service announcements.

Multiplexing and Signaling Regeneration: The system and method of the present disclosure incorporate multiplexing functionality to combine selected input sources and regenerate standard-compliant signaling information, ensuring compatibility with ATSC 3.0 standards.

The system of the present disclosure comprises three primary sections: Input Source Processor Block or circuitry, Gateway Block or circuitry, and Exciter Block or circuitry, each performing essential functions enabling TV stations to exercise greater control over their broadcast content while adhering to ATSC 3.0 standards.

In some non-limiting embodiments or aspects, each of the above-described functional blocks or circuitry (e.g., each of the Input Source Processor Block or circuitry, Gateway Block or circuitry, and/or Exciter Block, etc.) may be implemented by one or more computing devices and/or one or more processors and memory. In some non-limiting embodiments or aspects, the one or more processors may be implemented in hardware, firmware, or a combination of hardware and software. For example, the one or more processors may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), a device configured to implement logic functions, etc.) that can be programmed to perform a function. The memory may include random access memory (RAM), read-only memory (ROM), and/or another type of dynamic or static storage memory (e.g., flash memory, magnetic memory, optical memory, etc.) that stores information and/or instructions for use by the one or more processors.

The following is a step-by-step method in accordance with one non-limiting embodiment of the present disclosure:
1. Receive input from various sources including STLTP, ALPTP, Data Source, and off-air signals, and activate corresponding input source processors based on the received inputs, including the processing of local content if present within any of the input sources.
2. Convert the received inputs into a standardized format such as ATSC Link-layer Protocol (ALP) to ensure compatibility and standardization across different input types.
3. Remultiplexing (Remux) the standardized ALPs into new ALP groups based on broadcasting requirements, and then convert the remuxed ALPs into Baseband Packets (BBP) for further processing.
4. Analyze and modify/regenerate signaling information and configurations as necessary to ensure compliance with ATSC 3.0 standards and adapt to the new ALP groups.
5. Send the processed data, including remuxed ALPs, modified/regenerated signaling information, and configurations, to the Exciter Block to prepare the data for further modulation and transmission.

With reference to FIG. 1, the following is a description of the system in accordance with one non-limiting embodiment of the present disclosure:

The Input Source Processor Block or circuitry: This section encompasses a series of processors designed to accommodate various input types, including STL(TP), ALP(TP), DS (Data Source), local content, and off-air signal (RF). Depending on the number and types of inputs, the system dynamically adjusts to incorporate the necessary input source processors. These processors also play an important role in converting diverse input formats into the ALP format, ensuring compatibility and standardization across the system. The output ALP streams from these processors serve as standardized inputs for the Gateway Block or circuitry.

The Gateway Block or circuitry: This block or circuitry acts as a central hub for receiving and processing ALP streams from the Input Source Processors. Upon receiving ALP streams, the gateway performs remultiplexing operations to merge and organize the input streams into new ALP/PLP (Physical Layer Pipe) configurations. Subsequently, the gateway executes ALP-to-BBP (Baseband Packet) conversion to prepare the streams for modulation and transmission. Depending on the specific configuration, the gateway may integrate preamble and Time & Management (T&M) information with the BBP packets before routing them to the Exciter Block or circuitry, or the gateway may further process the combined streams into STL (Studio-to-Transmitter Link) format for transmission to the Exciter Block for further modulation and transmission. Additionally, the gateway includes a dedicated Signaling Processor responsible for parsing original signaling information extracted from the various input sources. This information undergoes thorough analysis and processing to regenerate new signaling and configuration data tailored to the remultiplexing process. Furthermore, the gateway regenerates T&M information and preambles as necessary, ensuring the integrity and compliance of the broadcast signal.

The Exciter Block or circuitry: This block or circuitry serves as the final stage in the signal transmission process, responsible for modulating the processed streams into a compliant ATSC 3.0 broadcast signal. The Exciter Block or circuitry receives inputs from the Gateway Block or circuitry, which may include the BBP streams along with preamble and Time & Management (T&M) information, or standard STL(TP) streams. It offers flexibility in accommodating different system configurations, whether the Gateway Block or circuitry and the Exciter Block or circuitry are integrated into a single unit or separate entities. Regardless of the chosen configuration, the Exciter Block or circuitry ensures the integrity and compliance of the broadcast signal, adhering strictly to ATSC 3.0 standards.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details of the disclosed subject matter are explained in greater detail below with reference to the exemplary embodiments that are illustrated in the accompanying figures, in which:

FIG. 1 is a block diagram of a system for enhanced ATSC 3.0 broadcasting;

FIG. 2 is a block diagram of the Input Source Processor of the system of FIG. 1;

FIG. 3 is a block diagram of the Gateway of the system of FIG. 1;

FIG. 4 is a block diagram of a portion of a system for enhanced ATSC 3.0 broadcasting according to one non-limiting embodiment of the present disclosure;

FIG. 5 is a block diagram of a portion of a system for enhanced ATSC 3.0 broadcasting according to another non-limiting embodiment of the present disclosure;

FIG. 6 is a schematic diagram illustrating broadcasts of different local content by different transmitters having overlapping areas;

FIGS. 7A and 7B are graphs illustrating signals in accordance with the present disclosure.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and provides or communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

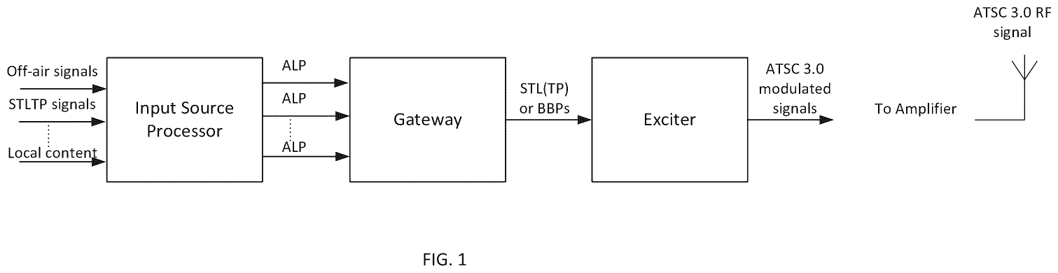

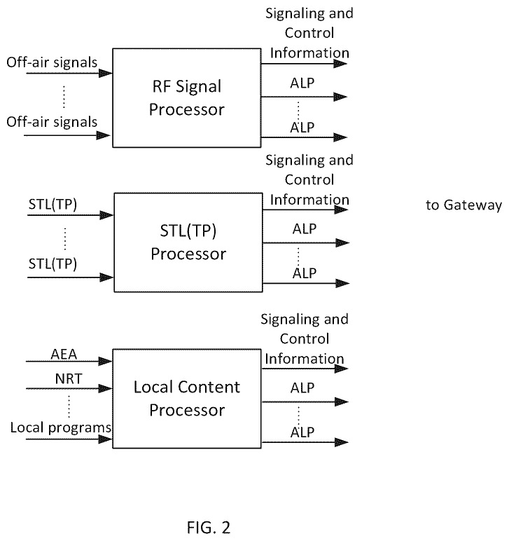

With reference to FIG. 2 and with continuing reference to FIG. 1, the RF Signal Processor, located within the Input Source Processor Block, receives and demodulates RF signals transmitted over the air. The RF Signal Processor includes a tuner and a demodulator and is configured to extract the baseband signal, which is then encapsulated into ALP (ATSC Link-layer Protocol) packets. These ALP-formatted data streams preserve the original content. The output may also include embedded signaling and metadata essential for downstream processing. The resulting streams are forwarded to the Gateway Block for further multiplexing and signaling regeneration.

The STL(TP) processor, located within the Input Source Processor Block, receives main streams transmitted over the IP network from the main studio(s). Typically, these streams originate from the broadcast gateway, containing essential signaling, configuration, Time & Management (T&M), and preamble information necessary for the exciter's operation. However, in the system of the present disclosure, the gateway function occurs downstream after all of the data processors. As a result, the STL(TP) processor must perform several tasks. Firstly, it converts the incoming STL(TP) streams back to ALP (ATSC Link-layer Protocol) format, ensuring compatibility with subsequent processing stages. Additionally, the processor extracts and outputs the signaling, configuration, T&M, and preamble information to the Signaling Processor in the Gateway Block or circuitry. This allows the Signaling Processor to update and regenerate this vital information as needed for the proper functioning of the broadcast signal.

The Local Content Processor, located within the Input Source Processor Block, is a versatile hub for managing and integrating various forms of localized content into the broadcast stream. Designed to handle a diverse array of content types, including local programs, emergency alerts, public service announcements (PSAs), and acknowledgments of financial support, this processor offers broadcasters a comprehensive solution for tailoring their broadcasts to meet community-specific needs. At its core, the Local Content Processor employs advanced processing algorithms to seamlessly combine and optimize localized content for integration into the broadcast stream. This includes the aggregation of audio and video streams, formatting for regulatory compliance, and encapsulation into standardized data packets. These packets are then bundled into ROUTE (Real-Time Object Delivery over Unidirectional Transport) or MMTP (MPEG Media Transport Protocol) encoding formats, ensuring efficient transmission and compatibility with downstream processing stages. The output format of the local content processor can be either the ROUTE or MMTP formats as described before, which is a standard format of the signaling server to the gateway so that the gateway performs a standard ALP generation before it performs any other processing. Alternatively, the Local Content Processor may pre-convert it into ALP just like other signal processors in the Input source processor block or circuitry so that the gateway block or circuitry receives all the same ALP formatted inputs. Both approaches offer advantages and may be implemented based on the broadcaster's preferences and system design considerations.

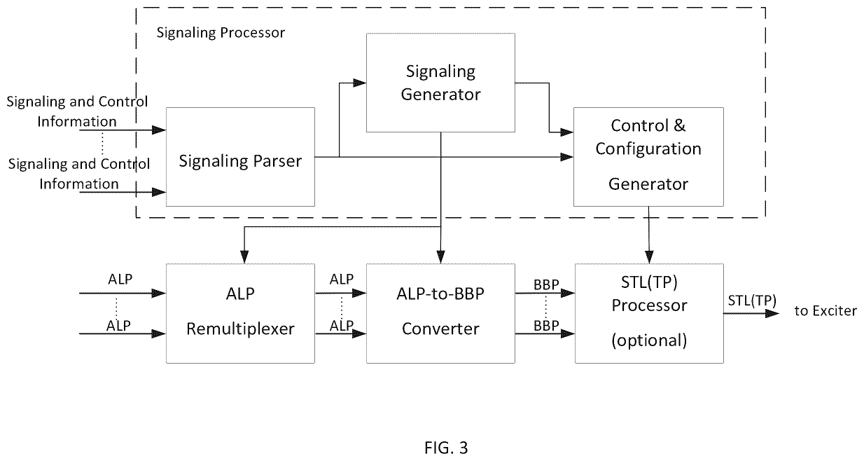

With reference to FIG. 3 and with continuing reference to FIG. 1, the Gateway Block or circuitry comprises several components: the ALP generator (optional), ALP remultiplexer, ALP-to-BBP converter, STL pre-processor (optional), and Signaling Processor.

The ALP generator, not shown in FIG. 3, is responsible for converting any input to the gateway that is not already in ALP format, such as data sources (ROUTE/MMTP). This functionality can also be integrated into some signal processors within the Input Source Processor Block or circuitry.

Next, the ALP remultiplexer aggregates all ALP inputs from different signal sources, including IP (STLTP), RF (off-air signal), and local content. It then manually or dynamically performs cherry-picking and remuxes them into one or multiple PLP configurations. The output of the ALP remultiplexer is directed to the ALP-to-BBP converter, which converts the ALPs into BBPs, preparing them for further processing by the exciter.

Optionally, the final component is the STL pre-processor. Its necessity depends on whether the gateway block or circuitry and the Exciter Block or circuitry are integrated into the same hardware platform, enabling internal data transmission. If so, preprocessing all BBPs and necessary control and configuration information into STLTP format may not be required before transmission to the exciter. However, the pre-processor can still convert all BBPs, along with necessary control and configuration information, into STLTP format if needed. Both approaches are disclosed by the present disclosure, ensuring flexibility and compatibility across different system configurations.

The Signaling Processor Block or circuitry facilitates seamless interaction with other key components. It comprises a Signaling Parser, a Signaling Generator, and a Control & Configuration Generator.

The Signaling Parser receives input from the Input Source Processor Block or circuitry and meticulously analyzes the signals to extract their original signaling, control, and configuration information. Any compressed signaling information, as defined by the ATSC 3.0 standard, undergoes decompression before extraction.

Subsequently, the Control & Configuration Generator retrieves the original control and configuration information, including Time & Management (T&M) and preamble data, from the output of the Signaling Parser. Depending on whether a modification is necessary, it either passes through the original data or generates new information. This information is then relayed to the Signaling Generator and integrated into other key components of the Gateway Block or circuitry.

Finally, the Signaling Generator receives inputs from both the Signaling Parser and the Control & Configuration Generator. It regenerates the new signaling information, utilizing it to interact with other critical components of the Gateway Block or circuitry.

Together, these functions ensure the seamless processing and regeneration of signaling, control, and configuration information, facilitating efficient operation and compliance with ATSC 3.0 standards within the Gateway Block.

With continued reference to FIG. 1, the Exciter Block or circuitry serves as the final stage in the signal transmission process within the system. Responsible for modulating the processed ALP/PLP streams into a compliant ATSC 3.0 broadcast signal, the Exciter Block or circuitry plays a role in ensuring the integrity and compliance of the broadcast signal. Depending on the system configuration, inputs from the Gateway Block or circuitry are received, which may include BBP streams along with preamble and Time & Management (T&M) information, or standard STL(TP) streams. The Exciter Block or circuitry offers flexibility to accommodate different configurations, prioritizing streamlined data processing or heightened data transmission security based on specific broadcasting needs. Ultimately, it adheres strictly to ATSC 3.0 standards, ensuring seamless integration and reliable broadcasting.

### Enhanced Broadcasting System and Method for SFN Settings:

The system and method described hereinabove effectively tackled limitations within the MFN framework. However, SFN settings introduce unique challenges. SFN requirements, as defined in ATSC 3.0, demand the transmission of identical content with synchronized timing across all transmitters to prevent on-channel interference. For example, a major TV network utilizing an SFN network for extensive coverage, needing to transmit localized content such as weather updates, emergency alerts, region-specific programming, and local advertising to specific areas within the coverage zone. Enabling the insertion of local content into SFN transmitters without violating SFN requirements and impacting SFN content reception poses a significant challenge.

Previous attempts to integrate local content delivery within SFN settings explored the use of Layer Division Multiplexing (LDM). LDM, a constellation superposition technology, combines multiple Physical Layer Pipes (PLPs) at different power levels, often with different modulation and channel coding schemes, before transmission in a single RF channel. LDM typically comprises at least two layers: the Core Layer (or Upper Layer) and one or more Enhanced Layers (or Lower Layers). The Core Layer is demodulated and decoded first in the receiver, followed by the Enhanced Layers.

An earlier approach suggested allocating the Core Layer of LDM for SFN content transmission and relegating local content to the Enhanced Layer. This method involved utilizing a high injection level to submerge the Enhanced Layer, minimizing its impact on the Core Layer content. However, this strategy overlooked crucial considerations regarding signaling information data, such as the Service List Table (SLT) and Link Mapping Table (LMT), which are important for both broadcasting and receiving. The SLT identifies all services transmitted within the broadcast streams across both the Core and Enhanced Layers, while the LMT provides a list of multicasts carried in PLPs and additional information for processing ALP packets carrying the multicasts in the link layer.

Failure to address the placement of signaling information within the LDM layers rendered previous attempts at local content delivery in SFN settings incomplete and impractical.

To address these challenges and limitations, the present disclosure proposes a modified system and method. Building upon the previously discussed framework for cherry-picking various inputs and inserting local content, the present disclosure introduces an approach that leverages LDM in SFN settings. This approach aims to enable the simultaneous transmission of region-wide and local content while ensuring SFN compliance. By addressing the intricacies of signaling information placement within LDM layers, the system and method of the present disclosure offers a more comprehensive and practical solution to the challenges posed by local content delivery in SFN settings.

The following outlines a modified broadcasting system and method that incorporates LDM within the SFN framework. Various configurations and structures exist to support local content insertion in SFN settings using LDM, with two common examples provided below. In the following non-limiting example there are N (N≥2) transmitters in the SFN configuration.

### Structure 1:

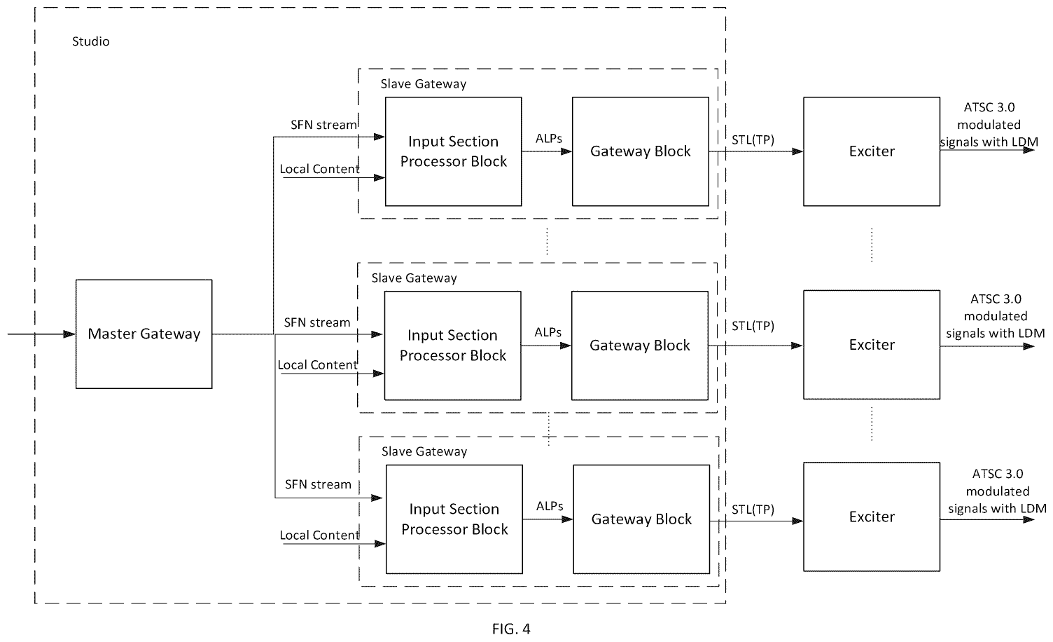

In this arrangement, as illustrated in the FIG. 4, the system comprises a Master Gateway, N Slave Gateways, and N exciters distributed across different transmitter sites within the SFN network. Synchronization among these components is needed and is achieved through common time reference mechanisms such as GPS or NTP, ensuring uniform timing alignment as mandated by SFN specifications.

The Master Gateway serves as a standalone ATSC 3.0 broadcast gateway, generating SFN streams containing region-wide content sent to the N Slave Gateways. The Master Gateway and the N Slave Gateways can either be collocated within the studio premises or distributed across diverse locations. Data exchange between the Master Gateway and Slave Gateways can occur in STL(TP) format or alternative formats, provided compatibility is maintained.

Each Slave Gateway receives identical SFN streams from the Master Gateway while also potentially ingesting diverse input sources, including but not limited to STL(TP) from secondary gateways, off-air signals (RF), and data sources (DS), denoted as local content for clarity. The Slave Gateways feature two primary functional blocks: the Input Source Processor Block and the Gateway Block or circuitry. The Input Source Processor Block consolidates all inputs including SFN streams from the Master Gateway and other distinct local content, ensuring unchanged SFN content while generating ALP streams for transmission to the Gateway Block or circuitry. This process demands synchronous reception and processing of SFN content across all Slave Gateways to adhere to SFN prerequisites.

The Gateway Block or circuitry in the Slave Gateway comprises key components including the ALP generator (optional), ALP remultiplexer, ALP-to-BBP converter, STL pre-processor (optional), and Signaling Processor. The additional features in this modified system for the Gateway Block or circuitry include 1) Preservation of unchanged SFN stream content and their original groups, and uniform processing speeds, delays, and buffering across all transmitters to uphold SFN integrity; 2) Parsing and modification or regeneration of Signaling Information together with T&M/preamble after local content insertion to encompass both SFN and local content; and 3) Adherence to common subframe parameters such as FFT size, pilot pattern, and guard interval, for multiple PLPs across different LDM layers, as stipulated by standard specifications.

Outputs from the Slave Gateways are directed to respective exciters located across SFN transmitter sites, with data transmission formats that can be STL(TP) adhering to the ATSC 3.0 standard or alternative formats. These exciters enable LDM encoding by integrating the Core Layer and Enhanced Layer, ultimately generating ATSC 3.0 waveforms for signal transmission.

### Structure 2:

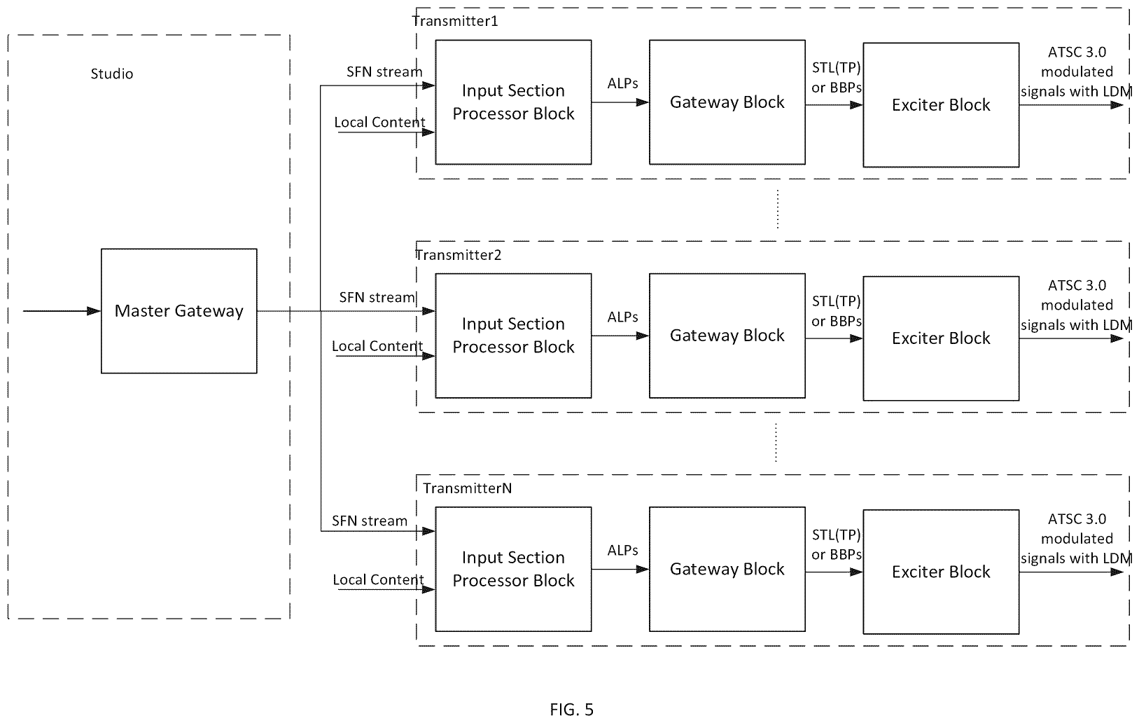

In this arrangement, as Illustrated in FIG. 5, the system comprises a Master Gateway and N exciters dispersed across various transmitter sites within the SFN network. Synchronization among these components is needed and is achieved through common time reference mechanisms such as GPS or NTP, ensuring uniform timing alignment as mandated by SFN specifications.

Within this structure, the singular Master Gateway functions as a standalone ATSC 3.0 broadcast gateway within the studio environment. Generating an SFN stream comprising region-wide SFN content, it disseminates this stream to the N exciters stationed at different transmitter sites. Data interchange between the Master Gateway and N exciters can transpire in STL(TP) format or alternative formats.

At each exciter, three primary functional blocks are essential for method implementation: the Input Source Processor Block or circuitry, Gateway Block or circuitry, and Exciter Block or circuitry. These blocks may either be separate entities or co-located within a unified unit.

The Input Source Processor Block or circuitry, serving as the initial functional block of each exciter, receives identical SFN streams from the Master Gateway while potentially ingesting various input sources, including STL(TP) from secondary gateways, off-air signals (RF), and data sources (DS), designated as local content for clarity. Tasked with converting incoming streams back to ALP format, it ensures the SFN content in PLP remains unaltered in sequence and processing speeds, delays, and buffering across all exciters.

The Gateway Block or circuitry comprises key components including the ALP generator (optional), ALP remultiplexer, ALP-to-BBP converter, STL pre-processor (optional), and Signaling Processor. The additional features in this structure for the Gateway Block or circuitry also include 1) Preservation of unchanged SFN stream content and their original groups, and uniform processing speeds, delays, and buffering across all transmitters to uphold SFN integrity; 2) Parsing and modification or regeneration of Signaling Information together with T&M/preamble after local content insertion to encompass both SFN and local content; and 3) Adherence to common subframe parameters such as FFT size, pilot pattern, and guard interval, for multiple PLPs across different LDM layers, as stipulated by standard specifications.

Outputs from the Gateway Block or circuitry mentioned above are directed to the Exciter Block or circuitry, with data transmission formats that can be STL(TP) adhering to the ATSC 3.0 standard or alternative formats. The Exciter block or circuitry enables LDM encoding by combining the Core Layer and Enhanced Layer, ultimately generating ATSC 3.0 waveforms for signal transmission.

The content placement configurations in LDM layers are described hereinafter.
1. Signaling Information Placement: The Core Layer of LDM is designated to accommodate signaling information due to its critical role in ATSC 3.0 reception. It should use a lower constellation and stronger code rate to ensure robust and reliable reception of essential signaling data. Given the Core Layer's priority in receiver demodulation and decoding, it is imperative that signaling information is placed here for guaranteed reception. Recommended constellation options include QPSK or 16QAM, with a preference for lower code rates to mitigate high required SNRs. This ensures that critical signaling information is reliably received by the receiver.
2. Content Allocation in Layers: In addition to signaling information, the Core Layer can also support other content types. One approach is to include region-wide SFN content alongside system-level signaling information, creating SFN streams within the Core Layer. Alternatively, the Core Layer can accommodate local content, while the Enhanced Layer is allocated for SFN transmission. Both approaches offer advantages depending on specific application requirements.

### Approach 1: SFN Content+Signaling Information in Core Layer/Local Content in Enhanced Layer

A. Signaling Information (SI): Because SI and SFN content are both placed in the CL, to meet SFN requirements, the SI in the Core Layer must be identical across all SFN transmitters, just as the SFN content, ensuring consistency in service identification and channel information. Even with varying local content in the Enhanced Layer, the SI must remain the same to uphold SFN integrity, which includes but is not limited to service IDs, channel names, major/minor channel numbers, etc.

B. SFN content: Since each Layer in LDM can use different ModCod (modulation & Code rate) combinations for different PLPs located in the same Layer, the region-wide SFN content here in this layer can have a different choice other than the SI, which means it can choose from various options described in the ATSC standard. For example, it can choose high modulation constellations such as 16, 64, 256 QAM, etc. for high data rates so that it can transmit more high-quality services such as HD and UHD programming. Other than the bitrate, it should also consider the required SNR threshold to guarantee the successful reception of the SFN content in the Core Layer.

C. Injection Level (IL): The injection level mentioned is the power difference between the Enhanced Layer to the Core Layer and its range is 0˜−25 dB, which means the Enhanced Layer can be as low as 25 dB lower than the Core Layer (when IL is −25 dB) and can be as high as the Core Layer (when IL is 0 dB). The choice of the IL directly impacts the required SNR threshold for both CL and EL after LDM is used, and therefore affects the coverage and reception rate. In this approach, because SFN content is in CL if the IL is near 0 dB, which means the local content in the EL is the same in power as the SFN content in the CL, which would become a strong on-channel interference to the SFN content and may potentially impact SFN reception. In this situation, a relatively larger negative IL is recommended to minimize such interference.

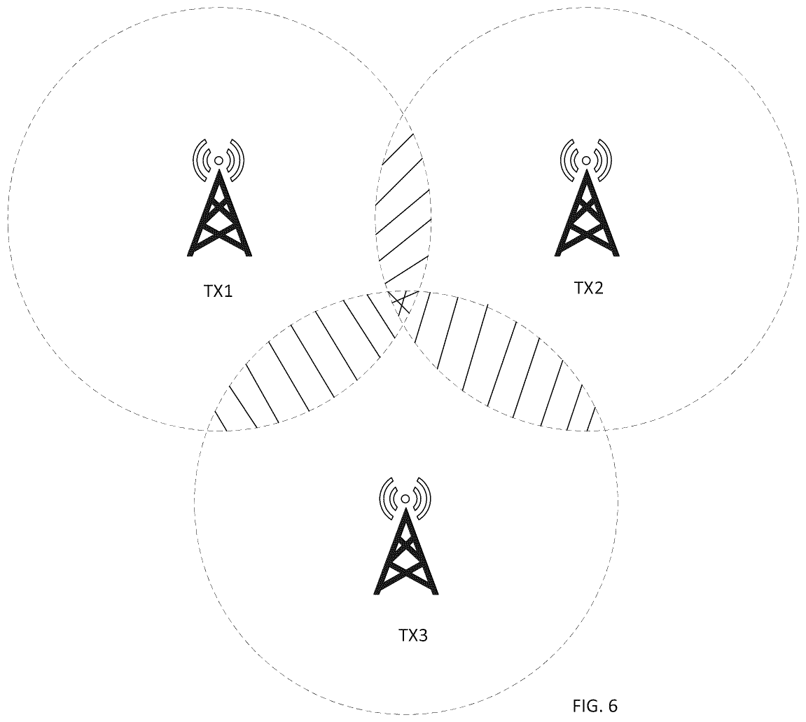

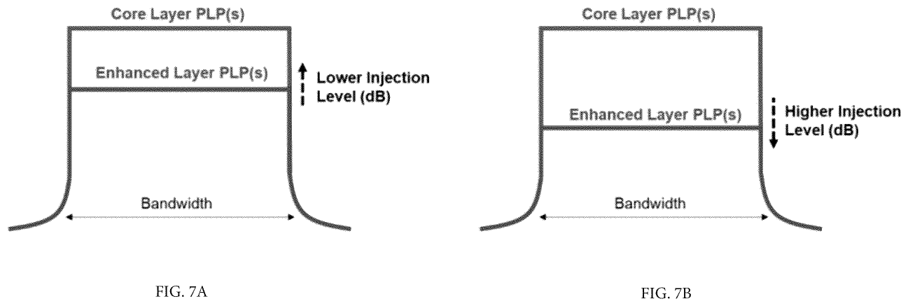

D. Local content: Since local content is placed in the Enhanced Layer and is lower power than the Core Layer, it is also important to choose a ModCod based on not only its bitrate but also the required SNR threshold requirement. A robust ModCod is preferred because: 1) if the IL is low in number (higher in its absolute value) (such as −15 dB) (reference to FIG. 7B), then the local content is so deep buried down underneath the CL that it would greatly increase the required SNR for a successful reception; and 2) after the Core Layer is decoded and canceled, the Enhanced Layer that broadcasts different local content by different transmitters in an SFN setting may have overlapping areas (reference to FIG. 6), which in this situation since the local content is different, they become unrelated on-channel interference to each other. Therefore, it is essential to choose carefully a ModCod that is relatively robust and preferably has a negative SNR threshold (before LDM).

### Approach 2: Local Content+Signaling Information in Core Layer/SFN Content in Enhanced Layer

A. Signaling Information (SI): While SI in the Core Layer must maintain robustness for MFN transmission, it does not need to be identical due to the absence of SFN requirements. This allows for customization of SI based on local content without constraints.

B. Local content: Since the local content is in the CL, which will be demodulated and decoded first, and in the overlap areas, the receiver may receive different local content from more than one transmitter in this SFN network. Because they are different in content, so they become unrelated on-channel interference to each other, which will increase the SNR threshold for reception. Therefore, it is important to choose a ModCod combination that has a relatively low (such as near zero) SNR threshold so that it can still be demodulated and decoded with co-channel interference.

C. SFN content: Now it is placed into the Enhanced Level and its assigned power is equal (IL=0) or less (IL<0) than the content in the CL. This could be considered burying it underneath the CL signal. This increases the SNR threshold for the SFN content reception as well. The ModCod combination chosen for SFN content should consider both the bitrate and the SNR threshold. The higher the bitrate is, the more HD or UHD programs it can transmit. But then it may increase the SNR threshold and make the reception more difficult and therefore the reduction in the coverage area. Luckily for the SFN content because they are identical per SFN requirement, so if CL has been successfully demodulated and decoded, and then canceled, then the remaining EL content is all SFN content, which means they are identical and synchronized. So even in the overlap areas, where the receiver may receive multiple SFN content from more than one transmitter in the SFN network since they are identical in content and synchronized in timing, they don't become on-channel interference to each other and may not affect the SNR threshold much.

D. Injection Level (IL): Again, the choice of the IL is important because it directly impacts the required SNR threshold for both CL and EL PLPs and will decide the coverage and reception rate. In this situation, because SFN content is in EL, if the IL is way below 0 dB, which means the SFN content in the EL is much lower in power compared to the local content in the CL, it would greatly increase the SNR threshold for reception and may fail the SFN reception. Therefore, a relatively small power difference between the two layers should be considered, and it means IL should be a smaller negative number (such as −3 dB) (reference to FIG. 7A). By doing this it may increase the CL SNR threshold for reception quite a bit because the EL power level is close and would become a strong on-channel interference, so a robust ModCod should be chosen by the CL content. The selection of ModCod combinations for both layers and the injection level should be a system consideration because they affect each other. Also, the coverage area between the Core Layer and the Enhanced Layer should be similar, which means that they have similar coverage and that includes the overlap areas where the receivers should also receive both the SFN content and local content.

### Embodiment 1

In this embodiment, the system adopts a structure as depicted in FIG. 4. For illustrative purposes, SFN content along with system-level signaling information is allocated to the Core Layer (CL), while local content resides in the Enhanced Layer (EL). While this configuration is presented as an example, please note that the system's flexibility allows for the inverse allocation.

The system comprises a Master Gateway, N Slave Gateways, and N exciters distributed across different transmitter sites within the SFN network, as previously described. The Master Gateway, operating as a standalone ATSC 3.0 system, generates SFN streams containing region-wide SFN content and system-level signaling information. This signaling information, including but not limited to SLT and LMT, encompasses services not only in the region-wide SFN content but also in the local content to be later inserted into broadcast streams by individual Slave Gateways. It's important to note that despite variations in local content, their signaling information must remain the same.

Each of the N Slave Gateways mentioned above is equipped with two primary functional blocks: the Input Source Processor Block or circuitry and the Gateway Block or circuitry. The Input Source Processor Block or circuitry receives identical SFN content and SI simultaneously, alongside distinct local content from an ATSC 3.0 encoder in ROUTE format, in this embodiment. Its role is to ensure unchanged SFN content and SI synchronous reception and processing of SFN content and SI across all transmitters, meeting SFN requirements. Furthermore, it generates ALP streams for transmission to the Gateway Block or circuitry.

The Gateway Block or circuitry receives all the ALP streams generated by the Input Source Processor Block or circuitry so that the optional ALP generator is not needed in this embodiment. In the ALP remultiplexer, it maps the SFN content and SI into designated PLPs for the Core Layer of LDM. For example, PLP0 may employ QPSK with a 4/15 code rate and short LDPC code for system-level SI, while PLP1 may use 64QAM with a 6/15 code rate and long LDPC code for SFN content. Both PLP0 and PLP1, originating from the Master Gateway streams sent to N Slave Gateways, maintain their content, sequences, and identical processing speeds, delays, and buffering across all transmitters to uphold SFN integrity. ALPs from local (MFN) content are then mapped to PLP(s) for the Enhanced Layer of LDM. For example, in can be PLP2 may utilize QPSK with a 2/15 code rate and short LDPC code for local content transmission. The subframe parameters such as FFT size, pilot pattern, and guard interval for both CL and EL shall be the same. The injection level can be set to −15 dB to ensure minimal interference between layers. Subsequently, the signals are sent to the ALP-to-BBP converter and then to the STL pre-processor before transmission to the Exciter Block.

Outputs from Slave Gateways are sent via STLTP format in this embodiment to N exciters located in different transmitter sites, following the ATSC 3.0 standard. Each exciter enables LDM encoding by combining the Core Layer and Enhanced Layer, ultimately generating ATSC 3.0 waveforms for signal transmission.

The Master Gateway, along with the N Slave Gateways and N exciters, must establish synchronization through a common time reference such as GPS or NTP. This ensures uniformity in timing across all components. Furthermore, it is imperative that the SFN content remains unchanged by all functional blocks of the Slave Gateways and undergoes processing at the same speeds, delays, and buffering among different Slave Gateways.

The required SNR of Core and Enhanced PLPs after LDM combining depends on the required SNR of Core and Enhanced PLPs before LDM combining, as well as the injection level. Using specific ModCod combinations and IL, SNR values can be calculated to ensure similar coverage areas for the successful reception of both SFN and local content.

The required SNR of Core PLPs (SNR_{CL_AC_SI} and SNR_{CL_AC_SFN}) and Enhanced PLP (SNR_{EL_AC_LOCAL}) after LDM combining can be calculated as:

$${SNR}_{CL \_ AC} = S N {R}_{CL \_ BC} + 10 {log}_{10} ( 1 + {10}^{\frac{- IL}{10}} ) - 10 {log}_{10} ( 1 - {10}^{\frac{{SNR}_{CL \_ BC} - IL}{10}} )$$

$$SN {R}_{EL \_ AC} = {SNR}_{EL \_ BC} + 10 {log}_{10} ( 1 + {10}^{\frac{I L}{10}} )$$

where IL is the absolute value of injection level in dB scale, SNR_{CL_BC} is the required SNR value in dB of the PLP that is assigned to the Core Layer (i.e., the required SNR before LDM combining), and SNR_{CL_BC_SI} is the SNR threshold for the SI, and SNR_{CL_BC_SFN} is the SNR threshold for the SFN content in CL. SNR_{EL_BC} is the required SNR value in dB of the PLP that is assigned to the Enhanced Layer (i.e., the required SNR before LDM combining) and SNR_{EL_BC_LOCAL} is the SNR threshold for the local content in EL before LDM.

According to their ModCod combination, in this embodiment, SNR_{CL_BC_SI}=−2.32 dB; SNR_{CL_BC_SFN}=7.66 dB, SNR_{EL_BC_LOCAL}=−5.55 dB, and IL=−15 dB, so that by the formulas above:

SNR_{CL_AC_SI}=−2.10 dB, almost the same as the SNR before LDM combining, because the IL is so low (−15 dB) that the EL content has minimal effect on the CL.

Similarly, SNR_{CL_AC_SFN}=8.68 dB, slightly higher than the 7.66 dB before the LDM combining.

SNR_{EL_AC_LOCAL}=9.58 dB because the EL is buried so deep down compared to the CL, that it has already greatly increased the SNR threshold of reception for 15 dB (almost the same as the absolute value of IL).

By selecting these ModCod combinations and IL, the SNR_{CL_BC_SFN}, and SNR_{EL_AC_LOCAL} is similar (8.68 dB vs 9.58 dB), and knowing that, it may help with planning the similar coverage and a successful reception and facilitating the simultaneous transmission of region-wide and localized content.

### Embodiment 2

In this embodiment, the system adopts a structure as depicted in FIG. 5. For illustration purposes, the local content along with system-level signaling information is allocated to the Core Layer (CL) while housing SFN content in the Enhanced Layer (EL). While this configuration is presented as an example, please note that the system's flexibility allows for the inverse allocation.

The system comprises a Master Gateway and N exciters dispersed across various transmitter sites within the SFN network, as previously described. The Master Gateway, functioning as a standalone ATSC 3.0 system, generates SFN streams containing region-wide SFN content and signaling information specifically tailored for SFN services, let's say the signaling information in PLP0 and SFN content in PLP1. The original signaling information encompasses services information solely for the SFN content, excluding any forthcoming local content insertion, which occurs at the transmitter sites. The Master Gateway transmits these streams via STLTP format to N exciters located in various transmitter sites in the SFN network.

At each exciter in the transmitter site, three primary functional blocks include the Input Source Processor Block or circuitry, Gateway Block or circuitry, and Exciter Block or circuitry. In this embodiment, these blocks are co-located within a single unit.

The Input Source Processor Block or circuitry receives SFN streams from the Master Gateway in STLTP format. It is tasked with converting incoming STLTP streams back to ALP format while ensuring the SFN content and their sequence remain unaltered and have the same processing speeds, delays, and buffering across all exciters. Simultaneously, the block receives respective local content, for example, off-air signals (RF), and converts these inputs into ALP streams for transmission to the Gateway Block or circuitry.

The Gateway Block or circuitry receives all the ALP streams generated by the Input Source Processor Block or circuitry, with no requirement for an optional ALP generator. The ALP remultiplexer within the Gateway Block or circuitry remaps the SFN content from its original PLP1 (set by the Master Gateway) to PLP2, preserving the original groups and reserving for the EL of LDM. Concurrently, local content ALPs are mapped into PLP1 reserved for the CL of LDM. The signaling processor in the Gateway Block or circuitry is responsible for parsing the original SI from inputs and editing/regenerating new SI together with T&M/preamble for all services, including both SFN content and local content, and sending them for PLP mapping. The new SI is then mapped into PLP0 and placed into CL of LDM. The subframe parameters such as FFT size, pilot pattern, and guard interval for both CL and EL shall be the same. Subsequently, the signals are processed by the ALP-to-BBP converter, and the BBP streams along with the new preamble and Time & Management (T&M) information are sent to the Exciter Block or circuitry. Given that all functional blocks are co-located into the same unit in this embodiment, there's no need to convert them into a standard STL(TP) format.

The Exciter block or circuitry receives all the signal from the Gateway block or circuitry and enables LDM encoding by combining the Core Layer and Enhanced Layer, ultimately generating ATSC 3.0 waveforms for signal transmission.

The Master Gateway, along with the N exciters, must establish synchronization through a common time reference such as GPS or NTP. This ensures uniformity in timing across all components. Furthermore, it is imperative that the SFN content remains unchanged by the functional blocks in the exciters at the transmitter sites and undergoes processing at the same speeds, delays, and buffering among different exciters. This stringent adherence to uniform processing is essential to uphold the integrity of the SFN.

As an example of Embodiment 2, PLP0 may employ a ModCod of QPSK with a 4/15 code rate and short LDPC code for system-level signaling information. PLP1 may utilize QPSK with an 8/15 code rate and short LDPC code for local content, placed in the CL of LDM. PLP2 may be designated for SFN content with a ModCod defined in the Master Gateway, such as 64QAM with a 4/15 code rate and long LDPC, mapped into the EL of LDM.

The required SNR of Core PLP (SNR_{CL_AC_SI} and SNR_{CL_AC_LOCAL}) and Enhanced PLP (SNR_{EL_AC_SFN}) after LDM combining can be calculated as the formula listed above:

So, in this embodiment, SNR_{CL_BC_SI}=−2.32 dB; SNR_{CL_BC_LOCAL}=1.38 dB; and SNR_{EL_BC_SFN}=4.15 dB.

If IL=−5 dB, then SNR_{CL_AC_SI}=−0.24 dB; SNR_{CL_AC_LOCAL}=5.05 dB; and SNR_{EL_AC_SFN}=10.34 dB.

If IL=−3 dB, then SNR_{CL_AC_SI}=0.95 dB; SNR_{CL_BC_LOCAL}=8.21 dB; and SNR_{EL_AC_SFN}=8.91 dB.

Users have the flexibility to choose different IL values, which directly impact the SNR thresholds for both layers.

The system and method of the present disclosure offer a solution to address the challenges faced by ATSC 3.0 broadcast systems in both MFN and SFN settings. By facilitating the selection of input sources, integration of local content, and regeneration of signaling information, the system empowers broadcasters to tailor content, enrich viewer engagement, and remain competitive in the dynamic broadcast landscape. Furthermore, the integration of LDM within SFN configurations enhances the system's capabilities, ensuring reception across multiple transmitters for both SFN and local content. With its innovative approach, the system not only ensures compliance with ATSC 3.0 standards but also provides flexibility and scalability to meet diverse broadcasting needs. This forward-thinking approach sets the stage for efficient and dynamic content distribution in the ATSC 3.0 ecosystem, fostering innovation and enhancing the broadcasting experience for broadcasters and viewers alike.

Although the disclosed subject matter has been described in detail for the purpose of illustration based on what is currently considered to be the most practical and preferred embodiments, it is to be understood that such detail is solely for that purpose and that the disclosed subject matter is not limited to the disclosed embodiments, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

What is claimed is:

1. A method for enhanced broadcasting in an ATSC 3.0 system, comprising:
selectively choosing among various input sources available to components within the system, including STLTP (Studio to Transmitter Link Transport Protocol), ALPTP (ATSC Link-layer Protocol Transport Protocol), DS (Data Source), and RF (off-air signals);
inserting local content into a broadcast stream by at least one component within the system; and
regenerating standard-compliant signaling information to ensure compatibility with ATSC 3.0 standards.

2. The method of claim 1, further comprising:
receiving input from various sources including STLTP, ALPTP, Data Source, and off-air signals, and activating corresponding input source processors based on the received inputs, including processing of local content if present within any of the received inputs;
converting the received inputs into a standardized format such as ATSC Link-layer Protocol (ALP) to ensure compatibility and standardization across different input types;
remuxing the standardized ALPs into new ALP groups based on broadcasting requirements, and then converting the remuxed ALPs into Baseband Packets (BBP) for further processing;
analyzing and modifying/regenerating signaling information and configurations as necessary to ensure compliance with ATSC 3.0 standards and adapting to new ALP groups; and
sending the processed data, including remuxed ALPs, modified/regenerated signaling information, and configurations, to an exciter to prepare the data for further modulation and transmission.

3. A system enhanced broadcasting for an ATSC 3.0 system, comprising:
an Input Source Processor configured to accommodate various input types, including STL(TP), ALP(TP), DS (Data Source), local content, and RF (off-air signal), and to convert diverse input formats into an ALP format;
a Gateway acting as a central hub for receiving and processing ALP streams from the Input Source Processor, performing remultiplexing operations, ALP-to-BBP conversion, and signal analysis and regeneration; and
an Exciter responsible for modulating processed streams into a compliant ATSC 3.0 broadcast signal, receiving inputs from the Gateway, and ensuring signal integrity and compliance.

4. A method for enhanced broadcasting in a Single Frequency Network (SFN) setting, comprising:
selectively choosing input sources for transmission by one component within the system in an SFN framework;
integrating local content into SFN transmissions while maintaining synchronization and compliance with SFN requirements;
regenerating standard-compliant signaling information tailored to SFN and local content.

5. A system for enhanced broadcasting in an SFN setting, comprising:
a Master Gateway for generating SFN streams containing region-wide content;
N Slave Gateways each equipped with an Input Source Processor and a Gateway for receiving and processing broadcast streams and local content;
N Exciters dispersed across transmitter sites for combining Core and Enhanced Layers using LDM for transmission; and
a synchronization mechanism for maintaining uniformity in timing for SFN contents across all components.

6. A system for enhanced broadcasting in an SFN setting, comprising:
a Master Gateway for generating SFN streams containing region-wide content;
N exciters dispersed across transmitter sites, each comprising an Input Source Processor, a Gateway, and an Exciter for receiving and processing SFN streams and localized content; and
a synchronization mechanism for maintaining uniformity in timing for SFN contents across all components.

7. A method for content placement in an ATSC 3.0 system utilizing Layer Division Multiplexing (LDM), comprising:
placing signaling information in the Core Layer of LDM to ensure robust and reliable reception, with a preference for lower constellation and stronger code rate options such as QPSK or 16QAM;
allocating the Core Layer for region-wide SFN content transmission alongside system-level signaling information, while assigning the Enhanced Layer for local content insertion;
ensuring identical signaling information in the Core Layer across all SFN transmitters to maintain consistency in service identification and channel information, thereby upholding SFN integrity; and
choosing an injection level (IL) for the Enhanced Layer to minimize interference with SFN content in the Core Layer, thereby optimizing reception conditions for both SFN and local content.

8. The method of claim 7, wherein the SFN content transmitted in the Core Layer utilizes different ModCod combinations to maximize data rates and quality, considering both the bitrate and required signal-to-noise ratio (SNR) thresholds.

9. A method for content allocation in an ATSC 3.0 system utilizing Layer Division Multiplexing (LDM), comprising:
placing local content and signaling information in the Core Layer, allowing customization of signaling information based on local content without constraints;
choosing ModCod combinations for local content in the Core Layer with relatively low SNR thresholds to ensure successful reception amidst co-channel interference;
assigning SFN content to the Enhanced Layer, with power levels equal to or less than the content in the Core Layer, to maintain SFN integrity and synchronized reception across all SFN transmitters; and
selecting an injection level (IL) for the Enhanced Layer to balance power levels between layers and optimize SNR thresholds for both SFN and local content reception.

10. The method of claim 9, wherein the selection of ModCod combinations and injection levels for both layers is a system consideration, ensuring similar coverage areas between the Core Layer and Enhanced Layer, including overlap areas where both SFN and local content are received.
